(19) United States
(12) Patent Application Publication
(10) Pub. No.: US 2007/0191217 A1
(43) Pub. Date: Aug. 16, 2007

(54) Method of manufacturing a catalysed ceramic wall-flow filter

(76) Inventor: Martyn Vincent Twigg, Cambridge (GB)

Correspondence Address: RATNERPRESTIA, P O BOX 980, VALLEY FORGE, PA, 19482-0980, US

(21) Appl. No.: 10/591,632

(22) PCT Filed: Mar. 7, 2005
(86) PCT No.: PCT/GB05/00870

§ 371 Date: Sep. 5, 2006

(30) Foreign Application Priority Data
Mar. 5, 2004 (GB) 0405015.9

(51) Int. Cl. B01J 21/00

(52) U.S. Cl. 502/254

(57) ABSTRACT

A method of manufacturing a catalysed ceramic wall-flow filter comprising a plurality of channels comprises reducing the pressure in a pore structure of the channel walls relative to the surrounding atmospheric pressure, contacting a surface of the evacuated channel walls with a liquid containing at least one catalyst component or a precursor thereof, whereby the liquid permeates the evacuated channel walls, and drying and calcining the filter containing the catalyst component or its precursor. An apparatus (100) for use in the method comprises means (120) for sealingly isolating a plurality of channels of a ceramic wall-flow filter (14) from the surrounding atmosphere, means (160, 200, 220) for reducing the pressure in the isolated channels to below the surrounding atmospheric pressure thereby to establish a vacuum in the pore structure of the filter walls, at least one reservoir (260) for holding a liquid containing at least one catalyst component or a precursor thereof and means (310, 300, 220) for dosing the isolated and evacuated channels with a pre-determined quantity of the liquid.

The present invention relates to a method of manufacturing a catalysed soot filter (CSF) and in particular to such a method wherein the filter is of the ceramic wall-flow type.

Filters for removing particulates from exhaust gas generated by a diesel engine are sometimes referred to in the art as diesel particulate filters (DPF).

It is known to load a catalyst and/or a washcoat on a honeycomb monolith substrate such as a ceramic flow-through monolith or a ceramic wall-flow filter. See for example our WO 2004/079167 (incorporated herein by reference). The coated monolith substrate is then dried and calcined to make the desired product. One apparatus for loading a catalyst washcoat onto a monolith substrate is disclosed in our WO 99/47260 (incorporated herein by reference).

A washcoat is generally a slurry, typically in an aqueous medium, comprising a high surface area particulate metal oxide such as ceria, silica, alumina, titania, zirconia, or a mixed oxide or composite oxide of any two or more thereof, e.g. ceria-zirconia, silica-alumina, a zeolite (a particular type of silica-alumina) etc. The washcoat and/or the metal oxide particles can include an active catalytic metal salt or compound such as a platinum group metal, e.g. platinum or palladium for promoting oxidation of carbon monoxide and hydrocarbons or rhodium for promoting NOₓ reduction in the presence of a hydrocarbon reducing agent; a molten salt to promote soot combustion e.g. an alkali metal salt, an alkaline earth metal salt or a lanthanum salt of vanadium, tungsten or molybdenum or vanadium pentoxide. Copper- and silver-based catalysts can also be used, such as silver or copper vanadates; a selective catalytic reduction (SCR) catalyst for reducing NOₓin an exhaust gas in the presence of a nitrogenous reductant such as ammonia, which catalysts include V₂O₅/TiO₂ and zeolites; and a compound of at least one of an alkali metal, an alkaline earth and a rare earth metal for absorbing NOₓ from a lean exhaust gas.

By “composite oxide” herein, we mean a largely amorphous oxide material comprising oxides of at least two elements which are not true mixed oxides consisting of at least two metals.

Alternatively, the monolith substrate material itself can be impregnated with a solution on a suitable aqueous salt of any of the above metals before the resulting piece is dried and calcined, as is also discussed in our WO 2004/079167. Of course, a washcoated monolith substrate that has been dried can also be impregnated using this method.

A typical wall-flow filter has a shape of a honeycomb, the honeycomb having an inlet end and an outlet end, and a plurality of cells extending from the inlet end to the outlet end, the cells having porous walls wherein part of the total number of cells at the inlet end are plugged along a portion of their lengths, and the remaining part of the cells that are open at the inlet end are plugged at the outlet end along a portion of their lengths, so that a flowing exhaust gas stream passing through the cells of the honeycomb from the inlet end flows into the open cells, through the cell walls, and out of the filter through the open cells at the outlet end.

It is known that CSFs require more porosity and generally larger pore sizes than non-catalysed filters to enable coating with catalyst systems. In order to have acceptably low pressure losses after being coated with the catalyst/washcoat systems at about 50 g/litre (1416 g/ft³) loading, typical porosity is about 45-55%. Where the catalyst system comprises a NOₓ storage/reduction system, higher washcoat loadings are usually required, possibly above 100 g/litre (2831 g/ft³). In this lafter embodiment, filter substrate porosity may be above 60%.

One method of loading the pore structure of a wall-flow filter with a catalyst washcoat is disclosed in EP-A-0766993 (incorporated herein by reference). One end of a honeycomb monolith is alternately plugged as described above. The plugged end is labelled the exhaust gas outlet end and is disposed with the plugged end uppermost. A washcoat composition is applied to plugged end which flows down the channels and permeates into the porous walls due to capillarity. To facilitate this process, the coating solution may be sucked through the monolith under vacuum. The resulting piece is dried and the other end of the monolith is plugged to generate a wall-flow filter having the above-described structure.

We have considered the method of EP-A-0766993 and do not believe it is of practical utility for a number of reasons. Firstly, the method is very labour intensive requiring a number of separate steps in order to generate the desired piece. For example, a better method would load a catalyst and/or washcoat on a virgin wall-flow filter, i.e. wherein both ends are already plugged. Secondly, the use of a vacuum does not guarantee insertion of the desired washcoat components in the pore structure of the filter. In particular, we have found that by applying a vacuum across the channel walls of a wall-flow filter, washcoat components can build up in a cake, preventing satisfactory ingress of the desired components into the pore structure of the monolith. However, relying on capillarity to introduce washcoat components in the pore structure particularly for more viscous washcoats, is time intensive.

We have now developed a method of loading a ceramic wall-flow filter with a catalyst and/or a washcoat wherein the problems associated with this prior art are reduced or avoided. A key feature of our method is that the pre-formed wall-flow filter is catalysed, i.e. no labour intensive end-plugging step is required after the filter substrate is catalysed, as in EP-A-0766993.

According to one aspect, the invention provides a method of manufacturing a catalysed ceramic wall-flow filter comprising a plurality of channels, which method comprising reducing the pressure in a pore structure of the channel walls relative to the surrounding atmospheric pressure, contacting a surface of the evacuated channel walls with a liquid containing at least one catalyst component or a precursor thereof, whereby the liquid permeates the evacuated channel walls, and drying and calcining the filter containing the catalyst component or its precursor.

Terms such as “low pressure” or “reduced pressure” are used herein interchangeably with the term “vacuum”.

An advantage of the present invention is that, by removing the air from the pore structure of the ceramic wall-flow filter prior to contacting the surface of the channel walls, we have found that the permeation of the liquid in the channel walls is greatly facilitated.

In one embodiment, the steps of contacting the evacuated channel walls with a liquid containing at least one catalyst component or its precursor and drying the filter is repeated at least once prior to the calcining step. This enables different catalyst components or their precursors to be prepared and loaded onto the filter separately where there may be some incompatibility between two formulations, e.g. pH.

According to a particular embodiment, pressure reduction in the pore structure of the channel walls is maintained during the liquid contacting step, for reasons explained below.

In the method, the liquid is left in contact with the filter in the vacuum for a period adequate to achieve permeation of the channel walls of the filter material, taking into account the mean pore size of the filter material, the specific gravity of the washcoat, its solids content, viscosity etc. This can be achieved by routine experimentation, but is typically of the order of 2 seconds to 2 minutes, such as 5-30 seconds. The coated filter is then released from the vacuum and dried and calcined according to known techniques.

The present invention contemplates loading the filter substrate with liquid containing at least one washcoat component, such as a particulate metal oxide surface area-increasing catalyst support material, typically in the form of a slurry in an aqueous medium. Since the washcoat component contributes to the activity of the catalyst, by increasing surface area, it can be regarded as a catalyst component. Generally, a D50 of the or each particulate metal oxide material is in the range 1-20 μm, with sizes in the lower range preferred such as <15 μm, or even as low as <5 μm. By carefully selecting the particle size according to the mean pore diameter in the filter substrate it is possible to prevent caking of the solid washcoat components at the surface of the channel walls.

In addition to the particulate metal oxide support material, the washcoat can also contain at least one catalyst component precursor comprising an aqueous solution of at least one metal salt, the metal being selected from any of those discussed below. Of course, the catalytic metal can be pre-formed on the support material, e.g. by incipient wetness impregnation then drying and calcining the powder, following which the pre-formed catalyst component is suspended in the aqueous medium. The skilled person will know that the precursor, e.g. a nitrate or acetate salt of a metal, is decomposed to the catalyst component per se, e.g. a metal oxide, following drying and calcination. By combining the support material and the precursor(s) in the washcoat, it is intended that the precursor(s) become dispersed principally on the support material.

Instead of, or in addition to, the particulate metal oxide component, the liquid component containing the at least one catalyst component can comprise a sol of at least one metal oxide material in a carrier medium, optionally water. A D50 of the sol particles is typically in the range 10-500 nm. The sol can also contain the salt of at least one catalyst component, i.e. the precursor.

Suitably, washcoat particulate size is selected so that it does not block a desired range of pore diameters for filtering diesel PM. Particulate size can be adjusted by known techniques, such as milling.

Typical loadings of the at least one washcoat-forming particulate metal oxide catalyst component or sol components in the catalysed ceramic wall-flow filter is from 20-120 g/litre (566-3398 g/ft³). As the skilled engineer is aware, a filter should not be washcoated to the extent that the backpressure in the system in use is too high for the filter to perform its function of collecting an adequate quantity of soot before the filter should be regenerated. Acceptable backpressures, in use, are up to 0.8 bar (1×10⁵ Pa) at a flow rate of 600 Kg hr⁻¹ at 600° C. Washcoat loading can be adjusted as appropriate by the skilled person to allow for sufficient soot loading before this threshold is reached, triggering an active regeneration in a system employing such a technique for regenerating the filter.

Alternatively, the filter can be impregnated with an aqueous solution of metal salts in the absence of sol or particulate support slurry forming components. In one embodiment, the catalyst precursor is supported directly by the filter material itself. In another embodiment, the salt solution can contain soluble salts of any of the metals commonly used as particulate support materials in a washcoat embodiment, e.g. salts of aluminium, cerium and/or zirconium, wherein the catalytic metals may also become supported by oxides of the support material following drying and calcining.

The at least one catalyst component or its precursor can comprise at least one component selected from the group consisting of aluminium, cerium, zirconium, titanium or silicon or a mixed oxide or composite oxide of any two or more thereof. Ceria (cerium oxide) is known to be catalytic for oxidation of certain exhaust gas components and its salts can be regarded as a catalyst precursor. Similarly, mixed oxides and composite oxides containing ceria, e.g. ceria-zirconia, are also known to be catalytic per se but with improved properties, e.g. thermal stability.

Metal salt components of the liquid for use in the invention can comprise at least one platinum group metal, optionally selected from the group consisting of platinum, palladium, rhodium, osmium and iridium; at least one base metal, optionally selected from the group consisting of copper, iron, vanadium, molybdenum, tungsten and cerium; and/or a basic metal selected from the group consisting of alkali metals, alkaline earth metals and rare earth metals. Additionally, catalyst components can include any of those discussed in the introduction above.

It will be appreciated that a vanadium compound such as V₂O₅, optionally supported on TiO₂, and iron supported on a zeolite such as zeolite Beta or ZSM-5 are active for catalysing reduction of NOₓ in a lean exhaust gas in the presence of a reducing agent such as ammonia and the invention contemplates catalysing a filter with such a SCR catalyst.

The invention also contemplates loading a NOₓ absorbing washcoat on the filter comprising an oxidation catalyst such as Pt and at least one compound of an alkali metal, e.g. potassium or caesium, at least one alkaline earth metal compound e.g. of barium, strontium, calcium or magnesium, typically barium, or a compound of at least one rare earth metal, such as yttrium or lanthanum. Catalysts for absorbing NO₂ from lean exhaust gas are known, e.g. from EP-A-0560991 (incorporated herein by reference). Typically present as oxides, in use, the compounds may take the form of hydroxides, nitrates or carbonates.

Suitable filter monolith materials for use in the present invention have relatively low pressure drop and relatively high filtration efficiency. The skilled engineer will be aware that a trade-off exists between porosity and mechanical strength: substrates of smaller pore size and lower porosity are stronger than those of high porosity. Thermal properties, both heat capacity and thermal conductivity, decrease with increasing porosity. However, since the filters of the present invention are intended for carrying a catalyst and optionally a washcoat, e.g. of about 50 g/litre (1416 g/ft³), suitable filter materials typically have a porosity of from 45-55% or even 60% and above for filters comprising NOₓ storage components at high washcoat loadings of up to about 100 g/litre (2832 g/ft³). A desirable feature of such materials is that they have good pore interconnectivity and as few closed or “dead end” pores as possible. Suitable mean pore diameters are from 5-40 μm, e.g. 8-25 μm, such as from 15-20 μm. The porosity values expressed herein can be measured by mercury porosimetry or electron microscopy.

Typically, the filter material comprises a ceramic material, comprising at least one of silicon carbide, aluminium nitride, silicon nitride, aluminium titanate, sintered metal, alumina, cordierite, mullite, pollucite (see e.g. WO 02/38513 (incorporated herein by reference)), a thermet such as Al₂O₃/Fe, Al₂O₃/Ni or B₄C/Fe, or composites comprising segments of any two or more thereof.

Preferred materials for making the filter of the present invention are cordierite (magnesium aluminium silicates), silicon carbide and aluminium titanates. Suitable cordierite type materials having the approximate stoichiometry Mg₂Al₄Si₅O₁₈ are disclosed in WO 01/91882 (incorporated herein by reference) and WO 2004/002508 (incorporated herein by reference), although alternatives such as lithium aluminosilicate ceramics can be used provided they have the required properties. Cordierite-type materials are generally characterised by a relatively low coefficient of thermal expansion (CTE) and low elastic (E) modulus.

Aluminium titanate materials for use in the present invention can include the 60-90% iron-aluminium titanate solid solution and 10-40% mullite described in WO 2004/011124 (incorporated herein by reference); or strontium feldspar aluminium titanate disclosed in WO 03/078352 (incorporated herein by reference).

Common cell geometries include 100/17, i.e. a configuration of 100 cells per square inch (cpsi) (31 cells cm⁻²) and 0.017 inch (0.43 mm) wall thickness, 200/12 (62 cells cm⁻²/0.30 mm), 200/14 (62 cells cm⁻²/0.36 mm), 200/19 (62 cells cm⁻²/0.48 mm) and 300/12 (93 cells cm⁻²/0.30 mm). The 200/19 configuration, for example, provides a more mechanically robust filter and an increased bulk volumetric heat capacity. Accordingly, cell densities for use in the invention can be from 50 to 600 cpsi (15.5 cells cm⁻² - 186 cells cm⁻²).

According to a further aspect, the invention provides an apparatus for use in the method according to any preceding claim, comprising means for sealingly isolating a plurality of channels of a ceramic wall-flow filter from the surrounding atmosphere, means for reducing the pressure in the isolated channels to below the surrounding atmospheric pressure thereby to establish a vacuum in the pore structure of the filter walls, at least one reservoir for holding a liquid containing at least one catalyst component or a precursor thereof and means for dosing the isolated and evacuated channels with a pre-determined quantity of the liquid.

In a first embodiment, the apparatus comprises a pressurisable container having a sealable closure for receiving a ceramic wall-flow filter. In a second embodiment, the apparatus comprises a first sealing member for receiving a first end of the ceramic wall-flow filter and a second sealing member for receiving a second end of the filter, wherein the pressure reducing means is associated with the first and/or the second member and the dosing means is associated with the first or second sealing member. In a particular embodiment of the second embodiment, the dosing means is associated with the first sealing (or base) member and the pressure reducing means is associated with the second sealing member. Depending on the porosity of the “skin” of the ceramic wall-flow filter, it may be necessary to embrace the skin in a flexible web of substantially impermeable material to reduce loss of vacuum in the channel walls and/or to reduce energy consumption by the pressure reducing means. Such sealing web may be provided by pads located on jaws of a robotic arm in an automated apparatus, for example.

In a particular embodiment of the apparatus according to the invention, means are provided for maintaining the reduced pressure in the isolated channels to below the surrounding atmospheric pressure during dosing of the liquid. Where the filter is disposed in a container and a vacuum is created in the container there will be some loss of vacuum in the filter material, and hence the filter material itself, when the liquid is introduced into the container from atmospheric pressure. It is within the scope of the present invention to compensate for such loss in vacuum by de-pressurising the container beyond a desired vacuum so that the loss in vacuum caused by introducing the liquid reduces the vacuum to that which is desired for promoting permeation of the liquid in the filter medium.

However, it may be desirable to prevent de-pressurising a filter substrate unduly, particularly in the higher porosity materials, since this may cause stresses to the substrate which may lead to failure of the part. Therefore, in the particular embodiment, the apparatus is arranged to return the vacuum in the container to the desired level following the introduction of the liquid medium to the container.

Advantageously, the apparatus can be at least semi-automated, comprising means for controlling both the means for reducing pressure in the isolated channels and the means for dosing the liquid.

Typical vacuum pressures for use in the present invention are 66.7-93.3 KPa (500-700 mm Hg). An aspect of the invention is that the entire filter is “soaked” in the vacuum. This prevents caking of washcoat components at a surface of a channel wall, e.g. as in the method disclosed in EP-A-766993.

In order that the invention may be fully understood, the following description of a specific embodiment of an apparatus according to the invention and an Example are provided by way of illustration only, wherein reference is made to the accompanying drawings, in which:

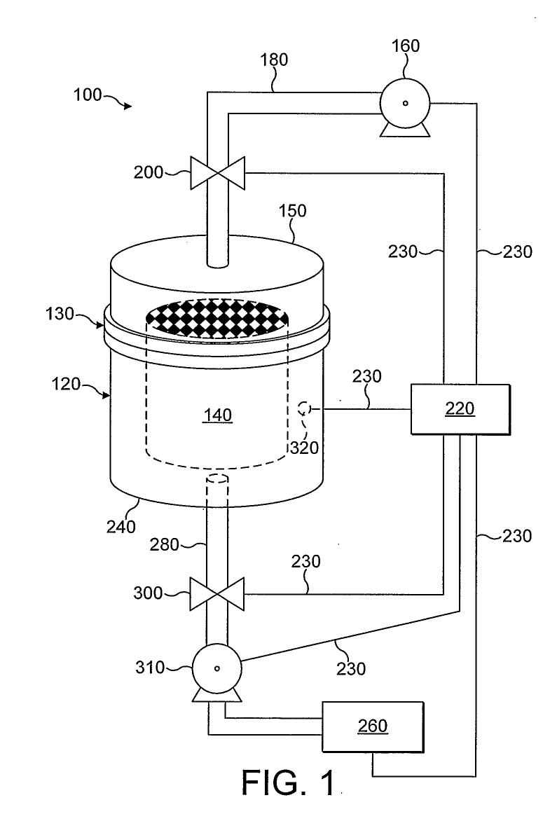

FIG. 1 is a schematic view of an apparatus according to an embodiment of the present invention;

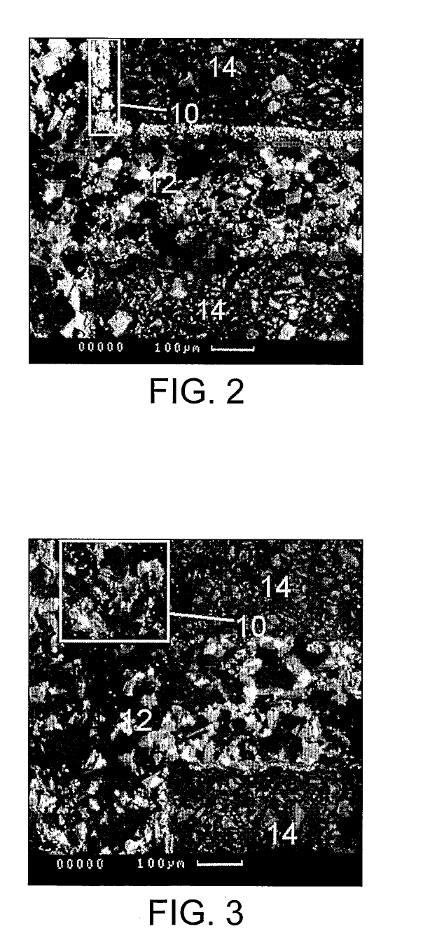

FIG. 2 is a back-scattered image of a resin-mounted sample of a catalysed DPF taken with a scanning electron microscope (SEM) showing the coating distribution for the method described in EP-A-0766993; and

FIG. 3 is a similar SEM image of a resin-mounted sample of a catalysed DPF obtained using the method described in the embodiment.

FIG. 1 shows an apparatus 100 for use in manufacturing a catalysed ceramic wall-flow filter according to the invention comprising a pressurisable container 120, with a sealable closure 130, for receiving a ceramic wall-flow filter 140 (shown in hashed lines). A first end 150 of the container 120 is connected to a vacuum pump 16 via pressurisible line 180. Opening valve 200 depressurises container 120, in use. Both the vacuum pump 160 and the valve 200 are controlled by a CPU 220 and are linked thereto by electrical connections 230. A second end, or base end, 240 of the container is connected to a reservoir 260 for holding a liquid containing at least one catalyst component or a precursor thereof via line 280. Valve 300 and pump 310, each also controlled by CPU 220, in combination provide a means for dosing the isolated and evacuated channels with a pre-determined quantity of the liquid. Level sensing means (not shown) in reservoir 260 may also be connected to CPU 220 in order to show a warning or actuate an alarm when the amount of liquid medium in the reservoir falls below a pre-determined level. The CPU 220 can also control mixing means (not shown) for controlling the mixing of the liquid medium in reservoir 260. For example, to ensure optimum dispersion of particulate components in a washcoat, mixing can be done continuously wherein a mixing rate is increased prior to dosing or mixing can be initiated prior to dosing and then switched off between dosing events.

In use, a first end 150 of the pressurisible container is removed from the second or base end 240 breaking the seal of sealable closure 130. Sealable closure 130 can comprise interlocking members (not shown) on first end 150 and second end 240 of the contained and an optionally expandable o-ring or gasket made from a rubber such as a synthetic rubber polymer. A ceramic wall-flow filter 140 is placed inside the base end of container 120 and the first end is replaced and the container 120 is sealingly closed. By means of vacuum pump 160 and valve 200 controlled by CPU 220, a pre-determined reduction of pressure in container 220 and filter 140 is achieved by feedback from sensor 320 to CPU 220. Next, CPU 220 activates mixing of a liquid washcoat composition in reservoir 260 and a predetermined dose of the liquid is introduced into the de-pressurised container 240 by means of pump 310 and valve 300 under control of CPU 220, whereby the liquid contacts the surfaces of the channel walls of the ceramic wall-flow filter 140. Since the pore structure of the filter material has been evacuated, the liquid components permeate the walls of the channels. CPU 220 controls pump 160 and valve 200 in response to a detected pressure in container 240 by sensor 320 to increase the vacuum in container 240 to compensate for any loss of vacuum during dosing of the liquid component, which may affect permeation of the liquid component into the channels walls.

### EXAMPLE

A 5.66 inch (14.38 cm) diameter, 6.00 inch (15.24 cm) long SiC diesel particulate filter (DPF) of 300 cpsi (46.5 cells cm⁻²), 12/1000^{th} inch (0.3 mm) wall thickness, 2.47 litre volume, was coated with 650 g of an alumina-based washcoat slurry (at 25% dry solids content) containing a soluble platinum group metal (PGM) salt and an organic reducing agent.

The coating process was carried out in a sealable and pressurisible stainless steel cylindrical vessel fitted with inlet and outlet valves (an adapted domestic pressure cooker). The DPF was first inserted into the vessel, the vessel was closed and then air was removed by a vacuum pump fitted to the outlet valve to give a reduced pressure inside the vessel relative to the surrounding atmospheric pressure. A reservoir of washcoat slurry was then connected to the inlet valve of the vessel and the washcoat was introduced into the vessel by opening the inlet valve. The DPF was left in contact with the coating slurry for between 5-30 seconds before the coated DPF was removed after returning the pressure inside the vessel to atmospheric conditions.

The washcoat was stabilized with compressed air then dried at 90° C. for 1 hour under a circulated air flow. The dry DPF was then calcined at 500° C. for 1 hour.

An identical SiC wall-flow filter was prepared using the same washcoat described above using the method described in EP-A-0766993.

A cross-section of each coated DPF was examined by back-scattered image scanning electron microscopy using a resin-mounted sample of each DPF to determine the coating location for the catalyst components of the washcoat. FIG. 2 shows the coating distribution for the method described in EP-A-0766993 and FIG. 3 for the distribution obtained using the method described in the embodiment of the invention. In the images, the catalytic component (10) shows up as white particles in contrast to the darker particles of the substrate (12) and the resin mounting material (14). It can be seen in FIG. 2 that the coating is dispersed less homogeneously throughout the walls of the filter compared to the dispersion in FIG. 3 and is slightly more noticeable at the edges and corners of the filter cells, suggesting caking of washcoat components at the surface of the channel walls.

1. A method of manufacturing a catalysed ceramic wall-flow filter comprising a plurality of channels, which method comprising the steps of:
(a) reducing the pressure in a pore structure of the channel walls relative to the surrounding atmospheric pressure,
(b) contacting a surface of the evacuated channel walls with a liquid containing at least one catalyst component or a precursor thereof, whereby the liquid permeates the evacuated channel walls,
(c) drying the filter containing the catalyst component or its precursor, and
(d) calcining the filter containing the catalyst component or its precursor.

2. A method according to claim 1, wherein steps (b) and (c) are repeated at least once prior to step (d).

3. A method according to claim 1, wherein the pressure reduction in the pore structure of the channel walls is maintained during the liquid contacting step.

4. A method according to claim 1, wherein the liquid contains the precursor and comprises an aqueous solution of at least one metal salt.

5. A method according to claim 1, wherein the liquid containing the at least one catalyst component comprises a slurry of at least one particulate metal oxide material in a carrier medium.

6. A method according to claim 5, wherein the D50 of the at least one particulate metal oxide material is in the range 1-20, μm.

7. A method according to claim 1, wherein the liquid containing the at least one catalyst component comprises a sol of at least one metal oxide material in a carrier medium.

8. A method according to claim 7, wherein the D50 of the sol particles is in the range 10-500 nm.

9. (canceled)

10. A method according to claim 1, wherein the loading of the at least one catalyst component in the catalysed ceramic wall-flow filter is from 20-120 g/litre.

11.-14. (canceled)

15. A method according to claim 1, wherein the material from which the ceramic filter is made is selected from the group consisting of silicon, silicon carbide, aluminium nitride, silicon nitride, aluminium titanate, alumina, cordierite, mullite pollucite and a thermet such as Al₂O₃/Fe, Al₂O₃/Ni or B₄C/Fe.

16. A method according to claim 1, wherein the virgin filter material has a porosity of 40-60%.

17. (canceled)

18. Apparatus for use in manufacturing a catalysed ceramic wall-flow filter, comprising means for sealingly isolating a plurality of channels of the ceramic wall-flow filter from the surrounding atmosphere, means for reducing the pressure in the isolated channels to below the surrounding atmospheric pressure thereby to establish a vacuum in the pore structure of the filter walls, at least one reservoir for holding a liquid containing at least one catalyst component or a precursor thereof and means for dosing the isolated and evacuated channels with a pre-determined quantity of the liquid.

19. Apparatus according to claim 18, wherein the means for sealingly isolating the plurality of channels comprises a pressurisable container having a sealable closure for receiving the ceramic wall-flow filter.

20. An apparatus according to claim 18, wherein the means for maintaining the reduced pressure in the isolated channels to below the surrounding atmospheric pressure comprises means for maintaining the reduced pressure during dosing of the liquid.

21. An apparatus according to claim 18, wherein the apparatus is at least semi-automated, to control both the means for reducing pressure in the isolated channels and the means for dosing the liquid.

22. A method according to claim 5, wherein the carrier medium comprises water.

23. A method according to claim 7, wherein the carrier medium comprises water.
